(19) United States
(12) Patent Application Publication
(10) Pub. No.: US 2007/0200527 A1
(43) Pub. Date: Aug. 30, 2007

(54) Stepping motor driving device

(76) Inventors: Takefumi Yamanoi, Ukyo-Ku (JP); Makoto Shimada, Osaka (JP)

Correspondence Address: CANTOR COLBURN, LLP, 55 GRIFFIN ROAD SOUTH, BLOOMFIELD, CT, 06002, US

(21) Appl. No.: 11/707,424

(22) Filed: Feb. 16, 2007

(30) Foreign Application Priority Data
Feb. 20, 2006 (JP) JP2006-042894

(51) Int. Cl. H02P 8/00

(52) U.S. Cl. 318/696

(57) ABSTRACT

With a stepping motor driving device, a driving signal generating unit generates a first driving signal and a second driving signal which are to be supplied to an A-phase coil and a B-phase coil of a stepping motor, respectively. A first switching circuit includes multiple switches connected to the A-phase coil of the stepping motor, and controls the current that flows through the A-phase coil according to a first driving signal generated by the driving signal generating unit. A second switching circuit includes multiple switches connected to the B-phase coil of the stepping motor, and controls the current that flows through the B-phase coil according to a second driving signal generated by the driving signal generating unit. The driving signal generating unit has a configuration which provides a function of adjusting the phase difference between the first driving signal and the second driving signal.

### BACKGROUND OF THE INVENTION

1. Field of the Invention

The present invention relates to a technique for driving a stepping motor.

2. Description of the Related Art

In recent years, various electronic devices, such as digital still cameras, digital video cameras, disk devices, printers, etc., include stepping motors for adjusting the positions of moving components such as lenses, pickups, heads, etc. A stepping motor is a synchronous motor, which rotates synchronously with an externally applied pulse signal, and which provides excellent starting, stopping, and positioning control. Furthermore, the stepping motor can be controlled in an open loop manner, and it is also suited to an arrangement using digital signal processing.

There are two methods for driving such a stepping motor, i.e., a unipolar driving method and a bipolar driving method. Patent documents 1 through 3 disclose stepping motor driving techniques using a unipolar driving method.
[Patent Document 1]

Japanese Patent Application Laid-Open No. Hei 9-103096
[Patent Document 2]

Japanese Patent Application Laid-Open No. 2004-120957
[Patent Document 3]

Japanese Patent Application Laid-Open No. 2000-184789

Such stepping motors are employed in various electronic devices such as digital still cameras, disk devices, printers, etc., as described above. Accordingly, development of such stepping motors has been advanced mainly with the aim of improving the positioning precision, efficiency, and so forth. With an application that requires such high precision positioning, a microstepping method is employed, in which the stepping motor is operated by gradually changing the ratio between the driving currents applied to the phase-stator windings adjacent to one another. Specifically, with such a microstepping method, a signal in the form of a sinusoidal waveform or a trapezoidal waveform is generated, where the slope of the waveform corresponds to the driving speed of the stepping motor, and a pulse signal is supplied to the stepping motor according to the signal thus generated.

As described above, the conventional stepping-motor driving methods have been developed with the aim of improving the positioning precision and the driving efficiency of the stepping motor. Thus, there is still room for improvement in the stepping driving method in terms of silent operation, i.e., in terms of suppressing the noise occurring in the motor (which will be referred to as “motor noise” hereafter).

### SUMMARY OF THE INVENTION

The present invention has been made in view of the aforementioned problem. Accordingly, it is a general purpose of the present invention to provide a driving device that offers a stepping motor with improved silent operation.

An embodiment of the present invention relates to a driving device for a two-phase stepping motor. The stepping motor driving device comprises: a driving signal generating unit which generates a first driving signal and a second driving signal for controlling the currents that flow through an A-phase coil and a B-phase coil of a stepping motor; a first switching circuit which includes multiple switches connected to the A-phase coil of the stepping motor, and which controls the current that flows through the A-phase coil according to the first driving signal which has been generated by and received from the driving signal generating unit; and a second switching circuit which includes multiple switches connected to the B-phase coil of the stepping motor, and which controls the current that flows through the B-phase coil according to the second driving signal which has been generated by and received from the driving signal generating unit. With such an arrangement, the driving signal generating unit is configured so as to provide a function of adjusting the phase difference between the first driving signal and the second driving signal.

With such an embodiment, the phase difference between the first driving signal and the second driving signal can be adjusted according to the properties of the stepping motor which is to be driven. This suppresses motor noise, thereby providing silent operation.

The driving signal generating unit may have a function of adjusting the phase difference between the first and second driving signals within a predetermined range with respect to a predetermined value. With such an arrangement, the predetermined value is set to 90 degrees, and the phase difference is shifted with respect to this base value, thereby suitably suppressing motor noise.

The driving signal generating unit may include a register which stores data that corresponds to the phase difference between the first and second driving signals.

The driving signal generating unit may include: a sinusoidal waveform signal generating unit which generates a first signal and a second signal in the form of sinusoidal waveforms with a predetermined phase difference; a phase adjustment unit which adjusts the phase difference between the first signal and the second signal; and a pulse width modulation signal generating unit which performs pulse width modulation for the first signal and the second signal output from the sinusoidal signal generating unit, and which outputs the first signal and the second signal thus modulated to the first switching circuit and the second switching circuit as the first driving signal and the second driving signal.

The sinusoidal waveform signal generating unit may include: a first sinusoidal waveform signal generating unit which generates the first signal; and a second sinusoidal waveform signal generating unit which generates the second signal with a predetermined phase shift along the time axis with respect to the first signal generated by the first sinusoidal waveform signal generating unit. Also, an arrangement may be made in which the first sinusoidal waveform signal generating unit and the second sinusoidal waveform signal generating unit generate the first signal and the second signal in the form of digital signals. With such an arrangement, the phase adjustment unit adjusts the phase difference by shifting digital data of the second signal by a period of time that corresponds to a predetermined number of clocks with respect to the first signal. Furthermore, an arrangement may be made in which one cycle of the signal in the form of a sinusoidal waveform is divided into N steps (in which N represents a natural number), and the second signal is shifted by M/N cycles (in which M satisfies the condition M<N). Also, M may be set to N/4+X (in which X represents an integer).

The driving signal generating unit may include: a sinusoidal waveform signal generating unit which generates a first signal in the form of a sinusoidal waveform; a phase adjustment unit which shifts the first signal, which has been output from the sinusoidal waveform signal generating unit, along the time axis by a predetermined shift amount, and outputs the first signal thus shifted as a second signal; and a pulse width modulation signal generating unit which performs pulse width modulation for the first signal and the second signal, which have been output from the sinusoidal waveform signal generating unit and the phase adjustment unit, respectively, and which outputs the first signal and the second signal having been thus subjected to pulse width modulation to the first switching circuit and the second switching circuit as the first driving signal and the second driving signal.

The driving signal generating unit may include: a first driving signal generating unit for generating a pulse-width modulated signal as a first driving signal, which is obtained by modulating the pulse width of a sinusoidal signal; and a second driving signal generating unit for generating a second pulse signal by shifting the first pulse signal, which has been generated by the first driving signal generating unit, along the time axis by a predetermined shift amount.

The components of the aforementioned driving device may integrally formed on a single semiconductor substrate. Examples of “components integrally formed” as used here include: an arrangement in which all the components of a circuit are formed on a semiconductor substrate; and an arrangement in which principal components of a circuit are formed on a semiconductor substrate, and a part comprising resistors and capacitors for adjusting the circuit constants is provided externally to the semiconductor substrate. With such an arrangement, the components of the driving device are integrally formed as a single LSI, thereby reducing the circuit area.

Another embodiment of the present invention relates to an electronic device. The electronic device comprises: a stepping motor; and the aforementioned stepping motor driving device which drives the stepping motor.

Such an embodiment provides a function of adjusting the phase of the current that flows through each phase coil of a stepping motor. This suppresses motor noise, thereby enhancing the commercial value of an electronic device that requires silent operation.

Yet another embodiment of the present invention relates to a stepping motor driving method. The stepping motor driving method comprises: a step for generating a first driving signal which is to be supplied to an A-phase coil of a two-phase stepping motor; and a step for generating a second driving signal, which is to be supplied to a B-phase coil of the stepping motor, by shifting the phase of the first driving signal within a predetermined range from a base of 90 degrees. With such a stepping motor driving method, the phase shift amount is optimized, thereby reducing the motor noise.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a stepping motor driving device according to an embodiment;

FIG. 2 is a circuit diagram which shows a configuration of a driving signal generating unit;

FIG. 3 is a circuit diagram which shows a specific configuration example of the driving signal generating unit;

FIG. 4 is a circuit:diagram which shows another configuration example of the driving signal generating unit; and

FIG. 5 is a waveform diagram illustrating the operation of the stepping motor driving device according to the embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

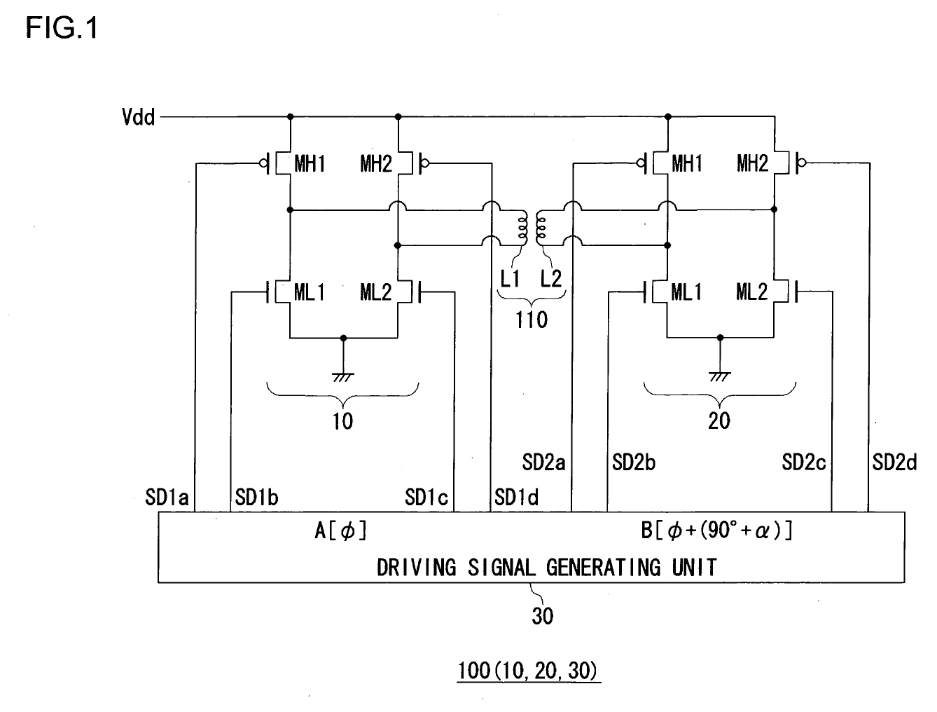

FIG. 1 is a circuit diagram which shows a configuration of a stepping motor driving device 100 according to an embodiment of the present invention. The stepping motor driving device 100 is mounted on an electronic device such as a digital camera, a printer, or the like, along with a stepping motor 110. The stepping motor, which is to be driven, is a two-phase stepping motor including an A-phase coil L1 and a B-phase coil L2, and which is employed for positioning a lens, a print head, or the like. The stepping motor driving device 100 is connected to the stepping motor 110 which is to be driven. With such an arrangement, the rotational operation of the stepping motor 110 is effected by supplying pulse-shaped driving signals SD1 and SD2 to the A-phase coil L1 and the B-phase coil L2.

The stepping motor driving device 100 according to the present embodiment uses a bipolar method to drive the stepping motor 110. The stepping motor driving device 100 comprises a first switching circuit 10, a second switching circuit 20, and a driving signal generating unit 30, which are integrally formed on a single semiconductor substrate in the form of a function IC.

The first switching circuit 10 includes four switches connected to the A-phase coil L1 of the stepping motor 110. The first switching circuit 10 controls the current that flows through the A-phase coil L1 according to the first driving signals SD1 (SD1a through SD1d) generated by the driving signal generating unit 30. Also, in the same way, the second switching circuit 20 includes four switches connected to the B-phase coil L2 of the stepping motor 110. The second switching circuit 20 controls the current that flows through the B-phase coil L2 according to the second driving signals SD2 (SD2a through SD2d) generated by the driving signal generating unit 30.

The first switching circuit 10 and the second switching circuit 20 have the same configuration. Each of the first switching circuit 10 and the second switching circuit 20 includes a first high-side transistor MH1, a second high-side transistor MH2, a first low-side transistor ML1, and a second low-side transistor ML2, which are disposed so as to form a so-called H bridge circuit. An unshown flywheel diode is provided between the drain and source of each of the transistors.

Description is being made in the present embodiment regarding an arrangement in which each high-side transistor comprises a P-channel MOSFET (Metal Oxide Semiconductor Field Effect Transistor), and each low-side transistor comprises an N-channel MOSFET. However, the present invention is not restricted to such an arrangement. Also, each high-side transistor may comprise an N-channel MOSFET. Also, each high-side transistor may comprise a bipolar transistor.

The driving signal generating unit 30 generates the first driving signal SD1 and the second driving signal SD2 such that the coil currents IL1 and IL2 flow through the A-phase coil L1 and the B-phase coil L2 in the form of generally sinusoidal waveforms with a phase difference of around 90 degrees.

The driving signal generating unit 30 according to the present embodiment has a configuration having a function of adjusting the phase difference between the first driving signal SD1 and the second driving signal SD2. With conventional techniques, the first driving signal SD1 and the second driving signal SD2 are generated with a phase difference of 90 degrees. On the other hand, the stepping motor driving device 100 according to the present embodiment has a function of adjusting the phase difference from 90 degrees by a predetermined angle of a degrees (in which a is a real number), thereby providing silent operation.

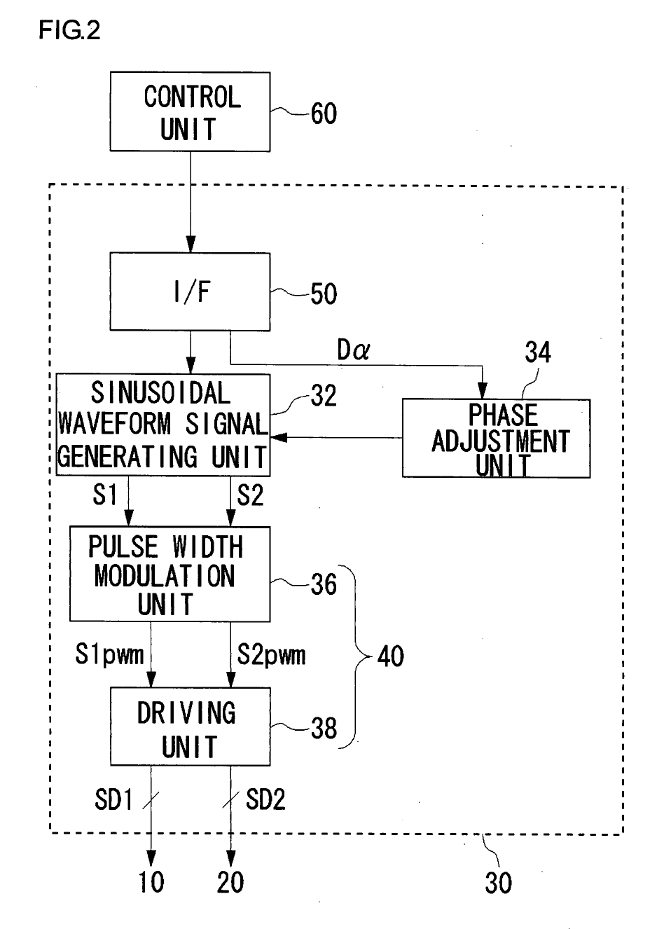

FIG. 2 is a circuit diagram which shows a configuration of a driving signal generating unit 30. The driving signal generating unit 30 includes a sinusoidal waveform signal generating unit 32, a phase adjustment unit 34, a pulse width modulation signal generating unit 40, and an interface unit 50.

A sinusoidal waveform signal generating unit 32 generates a first signal S1 and a second signal S2 in the form of sinusoidal waveforms having a predetermined phase difference. The term “signal in the form of a sinusoidal waveform” as used here represents a signal having a waveform similar to a sinusoidal wave. Examples of such signals in the form of a sinusoidal waveform include a signal obtained by clamping the top and bottom of a sinusoidal waveform, and a cyclic signal in the form of a trapezoid waveform, in addition to normal sinusoidal waveforms.

The interface unit 50 receives the data from the external control circuit 60 with respect to the phase difference between the first signal Si and the second signal S2 (which will be referred to as “phase difference data Dα” hereafter). The control circuit 60 may be provided in the form of a register, an ASIC (Application Specific Integrated Circuit), or the like. The phase difference data Dα is output from the interface unit 50 to the phase adjustment unit 34. The phase adjustment unit 34 adjusts the phase difference between the first signal S1 and the second signal S2 based upon the phase difference data Dα. The phase adjustment unit 34 adjusts the phase difference between the first signal S and the second signal S2 from a predetermined phase angle, i.e., 90 degrees, within a predetermined range (in a range of ±β degrees, for example).

The pulse width modulation signal generating unit 40 includes a pulse width modulating unit 36 and a driving unit 38. The pulse width modulating unit 36 modulates the pulse width of the first signals SI and the second signal S2, which are output from the sinusoidal waveform signal generating unit 32 and phase adjustment unit 34. The driving unit 38 generates a first driving signal SD1 and a second driving signal SD2 based upon the signals S1pwm and S2pwm output from the pulse width modulating unit 36 after the pulse width modulation. The first driving signal SD1 and the second driving signal SD2 thus generated are output to the first switching circuit 10 and the second switching circuit 20. The pulse width modulation signal generating unit 40 has the same configuration as that of a driving device of a typical stepping motor, and accordingly, description thereof will be omitted.

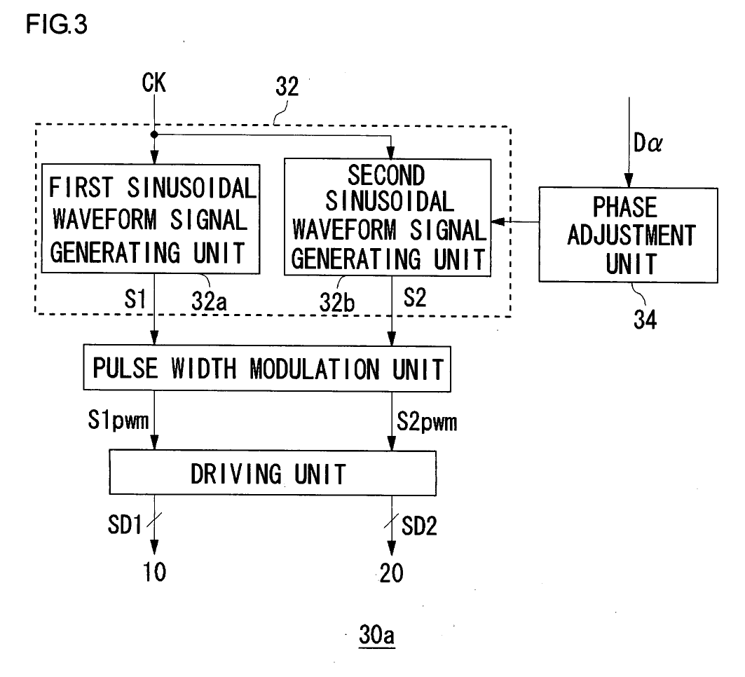

FIG. 3 is a circuit diagram which shows a specific configuration example of the driving signal generating unit 30. With a driving signal generating unit 30a shown in FIG. 3, the sinusoidal waveform signal generating unit 32 includes a first sinusoidal waveform signal generating unit 32a and a second sinusoidal waveform signal generating unit 32b. The first sinusoidal waveform signal generating unit 32a generates the first signal S1. On the other hand, the second sinusoidal waveform signal generating unit 32b generates the second signal S2 with a predetermined phase difference along the time axis from the first signal S1 generated by the first sinusoidal waveform signal generating unit 32a.

Each of the first sinusoidal waveform signal generating unit 32a and the second sinusoidal waveform signal generating unit 32b receives a clock signal CK from an external circuit. The first sinusoidal waveform signal generating unit 32a and the second sinusoidal waveform signal generating unit 32b count the clock signal CK and thereby generate the first signal S1 and the second signal S2 in the form of sinusoidal waveforms, in the form of serial digital signals.

The phase adjustment unit 34 shifts the digital data of the second signal S2 with respect to the digital data of the first signal S1 by a period of time that corresponds to a predetermined number of clocks, thereby adjusting the phase difference. With such an arrangement, the second sinusoidal waveform signal generating unit 32b starts to count the clock signal CK with a delay of a predetermined number of clocks from the point in time at which the first sinusoidal waveform signal generating unit 32a starts to count the clock signal CK. Such an arrangement provides a signal in the form of a sinusoidal waveform with a phase difference that corresponds to the predetermined number of clocks.

Such phase shifting may be performed as follows. First, one cycle of the signal in the form of a sinusoidal waveform is divided into N steps (in which “N” is a natural number). Subsequently, the second signal S2 is shifted with respect to the first signal S1 by M/N cycles (in which M satisfies the condition M<N). The number M is determined such that it satisfies the condition M=N/4+X (in which X is an integer).

For example, let us consider an arrangement employing a 10-bit counter for generating a sinusoidal waveform. With such an arrangement, the phase may be adjusted in increments of (360/1024) degrees by dividing one cycle into 1024 steps (M=1024). With such an arrangement, the signals are generated with a phase difference of 90 degrees by counting the clocks with a timing difference of 256 (N=M/4) clocks. Furthermore, upon further shifting the phase difference by a shift amount that corresponds to X clocks, two signals are generated in the form of sinusoidal waveforms with a phase difference shifted from the base phase difference of 90 degrees. The shift amount α is preferably adjusted at least within a range of 0 to 10 degrees, and is more preferably adjusted within a range of 0 to 15 degrees.

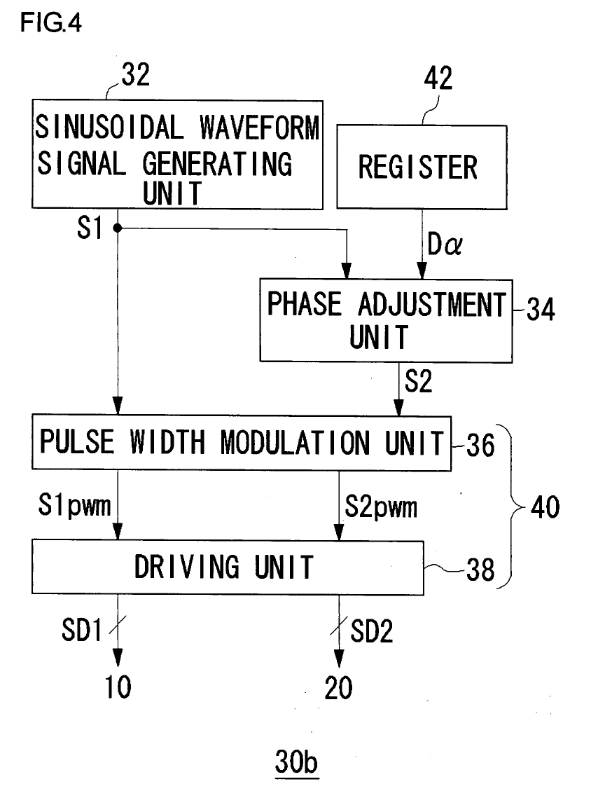

The configuration of the driving signal generating unit 30 is not restricted to that shown in FIG. 3. FIG. 4 is a circuit diagram which shows another example of the configuration of the driving signal generating unit. The driving signal generating unit 30b shown in FIG. 4 includes the sinusoidal waveform signal generating unit 32, the phase adjustment unit 34, the pulse width modulation signal generating unit 40, and a register 42.

The sinusoidal waveform signal generating unit 32 generates the first signal S1 in the form of a sinusoidal waveform, in the form of serial digital data. The phase adjustment unit 34 shifts the first signal S1 output from the sinusoidal waveform signal generating unit 32 along the time axis by a predetermined shift amount, and outputs the signal thus shifted as the second signal S2. The phase adjustment unit 34 may comprise a delay circuit, for example. The register 42 holds the data that corresponds to the phase difference a between the first driving signal SD1 and the second driving signal SD2. The phase adjustment unit 34 sets the shift amount based upon the data Dα held by the register 42.

Also, the driving signal generating unit may comprise a first driving signal generating unit for generating a first pulse signal subjected to pulse width modulation according to a signal in the form of a sinusoidal waveform, and a second driving signal generating unit for outputting a second pulse signal shifted along the time axis by a predetermined shift amount. That is to say, an arrangement may be made in which a pulse signal is directly generated using ROM or the like, and another pulse signal is generated by shifting the aforementioned pulse signal along the time axis, thereby generating two driving signals.

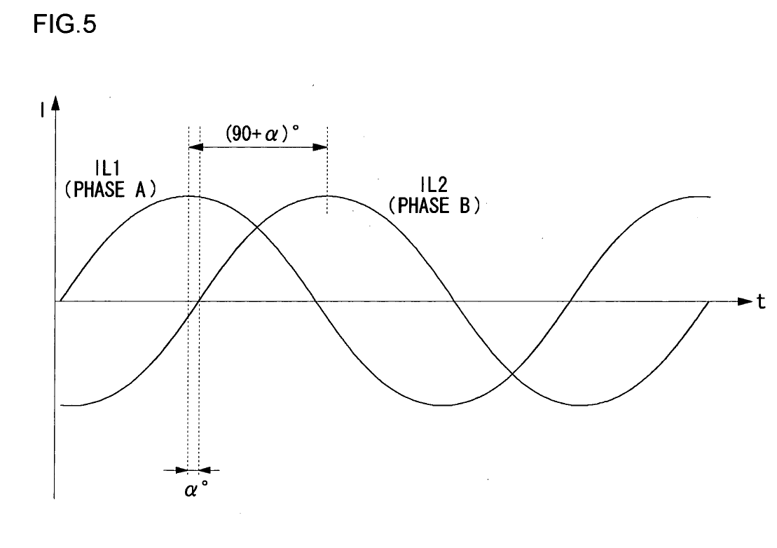

Description will be made regarding the operation of the stepping motor driving device 100 having such a configuration described above. FIG. 5 is a waveform diagram illustrating the operation of the stepping motor driving device 100 according to the present embodiment. FIG. 5 shows coil currents IL1 and IL2, which flow through the A-phase coil L1 and the B-phase coil L2, respectively. With the stepping motor driving device 100 according to the present embodiment, the first driving signal SD1 and the second driving signal SD2 are generated such that the B-phase coil current IL2 differs from the A-phase coil current IL1 by a phase difference of (90+α) degrees. As a result of experiments conducted with a number of stepping motors, it has been confirmed that silent operation is provided in an arrangement in which the shift amount α is set to within a range of 5 to 15 degrees, as compared with an arrangement which does not involve phase adjustment, i.e., an arrangement in which the shift amount a is set to zero.

With the stepping motor driving device 100 according to the present embodiment, the phase difference between the coil currents that flow through the A-phase coil L1 and the B-phase coil L2 is aggressively shifted from 90 degrees so as to reduce the motor noise occurring in the stepping motor 110, thereby providing silent operation. Note that, depending upon the kind, properties, etc., of the stepping motor 110 to be driven, the phase shift amount a may be experimentally determined such that motor noise is sufficiently reduced.

Furthermore, with the present embodiment, the stepping motor driving device 100 includes the phase adjustment unit 34. Such an arrangement has a function of using digital signal processing to perform fine adjustment of the phase difference between the coil current L1 and the coil current L2. This enables the configuration of such an arrangement to be modified in a simple manner as compared with an arrangement that employs chip components such as capacitors, resistors, etc.

While the preferred embodiments of the present invention have been described using specific terms, such description is for illustrative purposes only, and it is to be understood that changes and variations may be made without departing from the spirit or scope of the appended claims.

What is claimed is:

1. A stepping motor driving device comprising:
a driving signal generating unit which generates a first driving signal and a second driving signal for controlling the currents that flow through an A-phase coil and a B-phase coil of a stepping motor;
a first switching circuit which includes a plurality of switches connected to the A-phase coil of the stepping motor, and which controls the current that flows through the A-phase coil according to the first driving signal which has been generated by and received from said driving signal generating unit; and
a second switching circuit which includes a plurality of switches connected to the B-phase coil of the stepping motor, and which controls the current that flows through the B-phase coil according to the second driving signal which has been generated by and received from said driving signal generating unit,
wherein said driving signal generating unit is configured so as to provide a function of adjusting the phase difference between the first driving signal and the second driving signal.

2. A stepping motor driving device according to claim 1, wherein said driving signal generating unit can adjust the phase difference between the first and second driving signals within a predetermined range with respect to a predetermined value.

3. A stepping motor driving device according to claim 1, wherein said driving signal generating unit includes a, register which stores data that corresponds to the phase difference between the first and second driving signals.

4. A stepping motor driving device according to claim 1, wherein said driving signal generating unit includes:
a sinusoidal waveform signal generating unit which generates a first signal and a second signal in the form of sinusoidal waveforms with a predetermined phase difference;
a phase adjustment unit which adjusts the phase difference between the first signal and the second signal; and
a pulse width modulation signal generating unit which performs pulse width modulation for the first signal and the second signal output from said sinusoidal signal generating unit, and which outputs the first signal and the second signal thus modulated to said first switching circuit and said second switching circuit as the first driving signal and the second driving signal.

5. A stepping motor driving device according to claim 4, wherein said sinusoidal waveform signal generating unit includes:
a first sinusoidal waveform signal generating unit which generates the first signal; and
a second sinusoidal waveform signal generating unit which generates the second signal with a predetermined phase shift along the time axis with respect to the first signal generated by said first sinusoidal waveform signal generating unit.

6. A stepping motor driving device according to claim 5, wherein said first sinusoidal waveform signal generating unit and said second sinusoidal waveform signal generating unit generate the first signal and the second signal in the form of digital signals,
and wherein said phase adjustment unit adjusts the phase difference by shifting digital data of the second signal by a period of time that corresponds to a predetermined number of clocks with respect to the first signal.

7. A stepping motor driving device according to claim 1, wherein said driving signal generating unit includes:
a sinusoidal waveform signal generating unit which generates a first signal in the form of a sinusoidal waveform;
a phase adjustment unit which shifts the first signal, which has been output from said sinusoidal waveform signal generating unit, along the time axis by a predetermined shift amount, and outputs the first signal thus shifted as a second signal; and
a pulse width modulation signal generating unit which performs pulse width modulation for the first signal and the second signal, which have been output from said sinusoidal waveform signal generating unit and said phase adjustment unit, respectively, and which outputs the first signal and the second signal having been thus subjected to pulse width modulation to said first switching circuit and said second switching circuit as the first driving signal and the second driving signal.

8. A stepping motor driving device according to claim 1, wherein said driving signal generating unit includes:
a first driving signal generating unit which generates a first pulse signal subjected to pulse width modulation according to a signal in the form of a sinusoidal waveform; and
a second driving signal generating unit which generates a second pulse signal by shifting the first pulse signal, which has been generated by said first driving signal generating unit, along the time axis by a predetermined shift amount.

9. A stepping motor driving device according to claim 1, wherein said components are integrally formed on a single semiconductor substrate.

10. An electronic device comprising: a stepping motor; and a stepping motor driving device which drives said stepping motor, wherein said stepping motor driving device comprises:
a driving signal generating unit which generates a first driving signal and a second driving signal for controlling the currents that flow through an A-phase coil and a B-phase coil of a stepping motor;
a first switching circuit which includes a plurality of switches connected to the A-phase coil of the stepping motor, and which controls the current that flows through the A-phase coil according to the first driving signal which has been generated by and received from said driving signal generating unit; and
a second switching circuit which includes a plurality of switches connected to the B-phase coil of the stepping motor, and which controls the current that flows through the B-phase coil according to the second driving signal which has been generated by and received from said driving signal generating unit,
wherein said driving signal generating unit is configured so as to provide a function of adjusting the phase difference between the first driving signal and the second driving signal.

11. A stepping motor driving method comprising:
a step for generating a first driving signal which is to be supplied to an A-phase coil of a two-phase stepping motor; and
a step for generating a second driving signal, which is to be supplied to a B-phase coil of said stepping motor, by shifting the phase of the first driving signal within a predetermined range from a base of 90 degrees.
